(19) United States
(12) Patent Application Publication
(10) Pub. No.: US 2017/0291852 A1
(43) Pub. Date: Oct. 12, 2017

(54) Method & Composition for Improving Asphalt Cement Concrete Characteristics

(71) Applicant: Steven SANTA CRUZ, San Diego, CA (US)

(72) Inventor: Steven SANTA CRUZ, San Diego, CA (US)

(73) Assignee: Surface Tech LLC, Portland, OR (US)

(21) Appl. No.: 15/094,610

(22) Filed: Apr. 8, 2016

(51) Int. Cl. C04B 16/06

(52) U.S. Cl. CPC C04B 16/0691

(57) ABSTRACT

Reinforcing filaments or fibers, such as aromatic polyamide (aramid) fibers, can be reliably measured and consistently mixed into asphalt cement concrete by soaking the fibers in a wetting agent, then severing them to a desired length, and mixing the segments with other ACC ingredients. The wetting agent holds the fibers together loosely, so they can be distributed more uniformly throughout the ACC without clumping. The wetting agent soaks into the ACC mixture and/or evaporates, leaving the reinforcing fibers behind.

### CONTINUITY AND CLAIM OF PRIORITY

This is an original U.S. patent application.

### FIELD

The invention relates generally to a reinforcement composition and method of reinforcing asphalt and asphalt-concrete composite pavement. More specifically, the invention relates to methods of preparing reinforcing fibers and of using such fibers in the mixing of asphalt concrete pavement.

### BACKGROUND

Asphalt concrete or asphalt cement concrete (“AC,” “ACC” or often just “asphalt”) is widely used as a paving material to surface roads, runways and parking lots. By some estimates, up to 90% of all such surfaces are made with AC. A basic asphalt concrete comprises asphalt (also known as bitumen), a highly-viscous or semi-solid form of petroleum; and aggregates such as stone, sand or gravel, in about a 1:19 ratio (5% asphalt, 95% aggregate). The ingredients are heated, mixed, spread on the surface to be paved (often an earthen, stone or crushed-rock bed) and compacted to form AC. The asphalt (bitumen) binds the aggregate particles together, and when the temperature is “low enough,” the mixture is strong and tough. (At higher temperatures, asphalt cement concrete softens and can be damaged more easily. Thus, temperature is an important variable in all of mixing/manufacturing, application and service conditions.)

The energy required to heat the asphaltic binder for mixing and to keep the mixture hot during transport to the installation site is significant, so a variety of alternate formulations have been developed to improve the overall efficiency of the process. For example, the bitumen may be mixed with a lighter-weight petroleum solvent, or may be emulsified in a surfactant solution to produce an aggregate binder that functions at lower temperatures. These products are generally known as “warm mix asphalt” or “cold mix asphalt.”

A variety of trace ingredients can be added to asphalt concrete to improve its strength, durability, performance or construction characteristics. In addition, careful control of aggregate size, shape and composition can significantly improve AC characteristics. Because of the enormous amount of AC used around the world, even modest improvements in performance or handling can yield significant benefits.

In the context of a related paving material, cement concrete or Portland cement concrete, it is known that the introduction of various types of fibers to the basic Portland cement and aggregate mixture can improve strength and toughness of the resulting concrete. Similar fibers have also been used with asphalt concrete to good effect, but differences between cement concrete and asphalt concrete's manufacturing and handling requirements make it more difficult to introduce fibers into asphalt concrete. For example, the elevated temperatures and vigorous mixing required by AC damages or destroys many fibers that work well with cement concrete, and it is challenging to prevent small, lightweight fibers from blowing away before they are captured and secured into the asphalt/aggregate mixture.

One favorable method of introducing reinforcing fibers into standard (“hot mix”) asphalt concrete is described in U.S. patent application Ser. No. 14/031,002 by Lang and Sturtevant. The method is to prepare aramid-fiber segments coated or soaked with a binder that melts when the segments are introduced into the heated asphalt concrete during mixing. The elevated temperatures during mixing cause the binder to melt, releasing both fibers and binder into the AC, where further mixing distributes them.

Alternative methods of introducing reinforcing fibers into warm- and cold-mix asphalt concrete may provide greater control over the quantity and distribution of the fibers in the finished pavement, leading to improved pavement characteristics, improved energy-efficiency and reduced construction cost.

### SUMMARY

Embodiments of the invention pre-treat reinforcing fibers with a wetting agent before introducing segments of the treated fiber into an asphalt concrete mixture. The wetting agent weighs down the segments, binds the fibers together loosely through surface tension and reduces fibrillation so that the segments are less likely to be carried away by heat and turbulence before they are captured into the AC mix. Once captured, the wetting agent evaporates or degrades and leaves the fibers behind.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a flow chart outlining a method for making and using a fiber asphalt-concrete reinforcing material.

FIG. 2 shows a spool of reinforcing-fiber yarn.

FIG. 3 shows sample cross-sections of the treated reinforcing fiber yarn.

FIG. 4 shows two flat plates held together by a fluid between them.

### DETAILED DESCRIPTION

Embodiments of the invention address challenges arising in the manufacture of certain types of asphalt concrete for paving and other applications. Standard AC is manufactured at elevated temperatures, which liquefy the bitumen and ensure that aggregate particles are well coated during mixing. The heating consumes a large amount of energy, particularly when ambient temperatures are low. The mixed AC must be kept warm during transport as well. Prior-art reinforcing fiber additives rely on manufacturing heat to release fibers held together by a meltable binder, where both the fibers and the binder substance end up in the finished AC mix.

In many applications, however, lower-temperature binders may be preferred: less energy is required to make and transport the AC, and the service conditions may not demand the high-temperature performance of hot-mix AC. Unfortunately, in warm-mix and cold-mix asphalt concrete, manufacturing temperatures may not be high enough to melt binders and release fibers from prior-art additives. Thus, in an embodiment, reinforcing fibers are soaked with a wetting agent having a higher vapor pressure and/or lower melting point than prior-art binders, so that the fibers are kept together for improved handling, but are released into the warm-mix or cold-mix AC during mixing as the wetting agent evaporates or degrades.

In some embodiments, a portion of the wetting agent may remain in the finished AC, but in preferred embodiments, all or substantially all of the wetting agent evaporates and departs, leaving only the reinforcing fibers behind.

In one embodiment, the wetting agent is water. In other embodiments, the wetting agent may be mostly water, but may be treated with a surfactant or pH modifier to improve wetting of the reinforcing fiber bundles. The reinforcing fibers may be, for example, aramid fibers. Each bundle may contain 250-15,000 individual filaments. Each filament in a bundle may be substantially the same length, and bundles may be prepared by soaking a rope or yarn of fibers and then cutting it into segments of a desired length. The fiber bundles prepared this way contain filaments that are mostly parallel.

The segments may be placed in an airtight container such as a plastic bag or tub for transport and storage, so that the wetting agent does not evaporate before the soaked segments are metered into the AC mixture. In some embodiments, all of soaking, severing and metering can be performed as the AC is manufactured (i.e., just-in-time preparation).

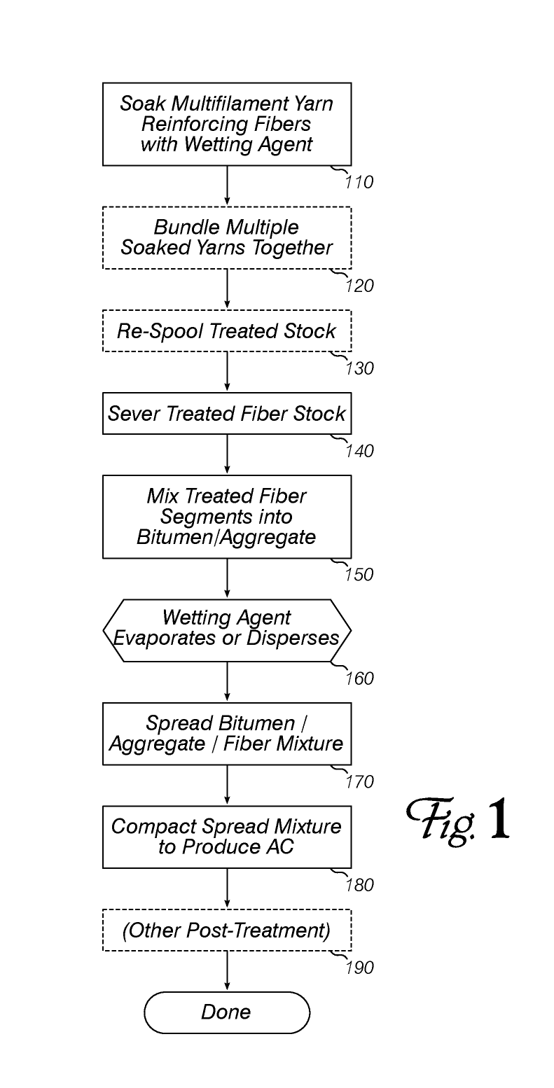

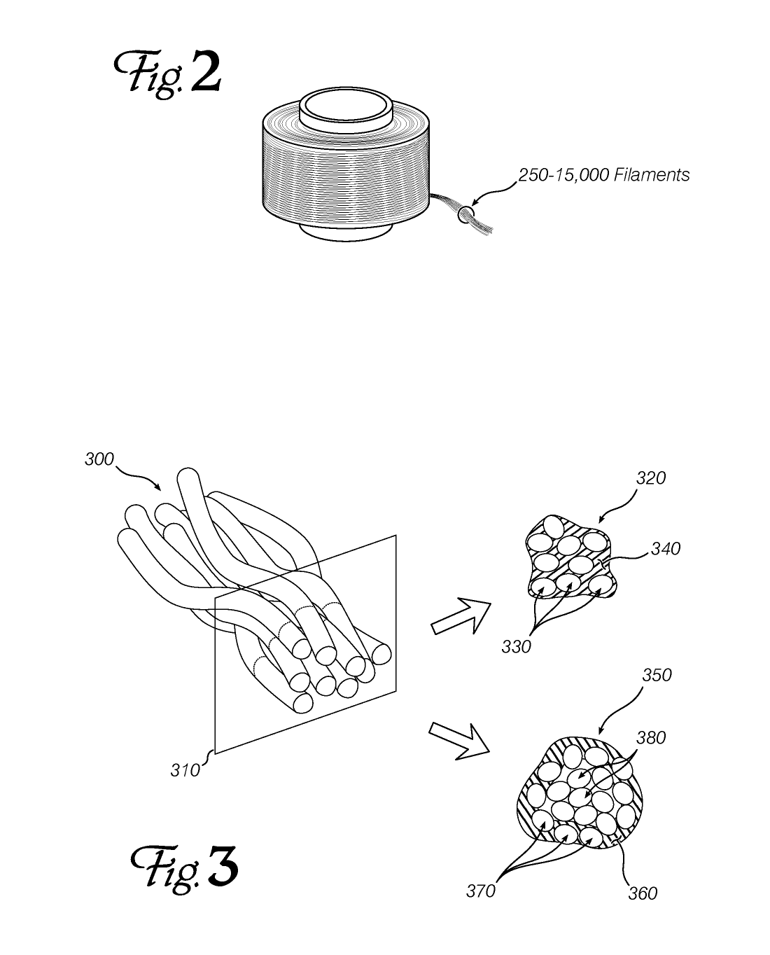

FIG. 1 outlines a method of manufacturing and installing asphalt concrete according to an embodiment of the invention. This method uses reinforcing fibers supplied in yarn form (e.g., FIG. 2). The individual reinforcing fibers are very thin—on the order of 5-15 microns in diameter—and are organized into roughly parallel bundles containing 250-15,000 filaments. The yarn may be twisted or untwisted.

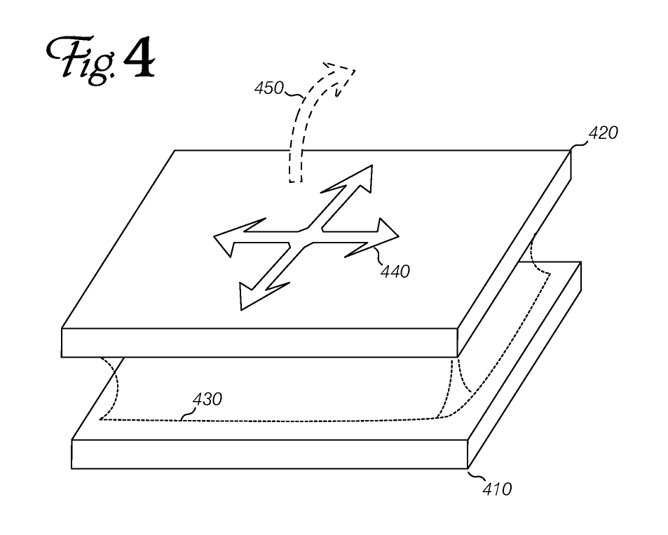

First, a length of multifilament reinforcing fiber yarn is soaked with a wetting agent (110). For example, the bare twisted or untwisted fiber yarn may be dipped into water, sprayed with water, or exposed to pressurized steam to soak the fibers. The treatment results in a structure like that shown in FIG. 3: the bundle of fibers 300 (only a few of which are shown here), has a cross section (310) like that shown at 320, where the fibers 330 are mostly coated or soaked with wetting agent 340; or like that shown at 350, where the wetting agent 360 has only penetrated the outermost filaments 370, while the interior filaments 380 are mostly dry.

In some embodiments, a plurality of treated yarn segments may be joined together by twisting, coating and/or soaking in the same or a different wetting agent to produce a treated reinforcing fiber “rope” with physical structure similar to a multi-strand wire rope (120). The tensile-strength characteristics of such a rope are not especially important to embodiments of the invention, so it is not critical that the individual fiber bundles be of a particular size, shape, twist or other configuration.

The treated (soaked) fiber stock may be re-spooled for storage or transport (130). If stored in this state, the stock should be kept in an airtight container to prevent the wetting agent from evaporating.

Next, at a convenient time prior to the introduction of the treated fiber into an asphalt-aggregate mixture, the treated fiber is severed into segments of suitable length (140). Good results have been obtained with segments of about 20 mm, but segments between about 8 mm and about 100 mm may be suitable for some combinations of bitumen/aggregate ratios, aggregate sizes, mixing and/or installing machinery, and other factors. As will be discussed below, longer segments are favored for embedment, crack resistance and spreading loads over larger areas of the finished pavement, while shorter segments are less likely to form clumps that provide limited reinforcement to the pavement. In general, segment length is a results-effective variable that can be tuned to adjust an embodiment to attain various material-handling and pavement characteristic goals.

In some AC manufacturing processes, bulk (uncut) wetted reinforcing fiber yarn may be cut to a length controlled in a feedback loop by the characteristics of the asphalt concrete mix exiting the mixing process. This permits variations in bitumen quality, aggregate condition, temperature and other environmental conditions to be accommodated. Even when fixed segment lengths are used, the segments may be cut from a bulk spool of treated fiber at the point where the segments are introduced into the mix (rather than being pre-cut and supplied in bags or similar containers).

Since the wetting agent should have a substantial vapor pressure under ordinary conditions (e.g., “room temperature,” or even just higher than about 5-10° C.), treated fibers should be stored in a closed, airtight bag or container to prevent the wetting agent from evaporating before the fibers are cut and mixed into the AC.

The number of individual filaments in each segment depends on the number of individual filaments in the original yarn, and (optionally) the number of treated yarns combined together into a treated fiber rope. Each segment may have, for example, 250-15,000 filament segments, or a number of filaments approximately equal to the sum of the filament counts of the yarns comprising the rope.

The severed segments of treated fiber are introduced into the asphalt mix on a suitable volumetric basis (150). The amount of fiber (e.g., by weight, exclusive of the wetting agent) is fairly small—on the order of tens to hundreds of grams (perhaps up to a few kilograms) per metric ton of AC. Thus, it is preferred that the introduction means be able to meter the treated fiber segments accurately and without significant variation caused by misfeeding, material swarf, or other confounding factors. Further, reliable metering is important because an asphalt plant may produce hundreds or thousands of tons of material during a single shift. Reliable, unattended metering from a large bulk store reduces the labor cost of producing AC mix, and increases the consistency of the output. Pre-cut segments may be metered from a bulk bin or hopper by means of a screw-auger conveyor system, a vibratory feeder, a pneumatic or vacuum system. (In other words, the pre-cut form factor is compatible with existing additive feed systems.)

The reinforcing fibers in a segment are held together by surface tension with the wetting agent. FIG. 4 shows a similar, but simpler, arrangement: two flat plates 410 and 420 are separated by a thin liquid layer 430. The liquid may have been coated onto one surface and the other brought near, or capillary action may have drawn liquid placed near an edge of the narrowly-separated plates into the space between them. At any rate, surface tension between the plates and the thin liquid layer allows the plates to slide parallel to each other (shear motion 440), but they cannot easily be pulled apart (450). Similarly, in an embodiment, moistened or soaked filaments in a segment can be pulled out parallel to the fiber, and some outside filaments can be peeled away from the segment, but surface tension between the fibers and the wetting agent helps keep most of the filaments together as the segment is mixed into the AC. Thus, filaments are pulled out or peeled off gradually and are distributed throughout the AC more evenly as the wetting agent soaks into the AC mixture, evaporates or is otherwise dissipated.

Since the reinforcing fibers in each segment are held together by surface tension with the wetting agent, each segment behaves like a moderately-heavy lump of material and can be blended effectively into the bitumen-aggregate mixture so that individual filaments become oriented in essentially random three-dimensional directions between aggregate particles as they are peeled away from the lump. In contrast, if an equivalent quantity of untreated fibers were introduced at the same point, the filaments would be much more likely to escape as airborne lint, to foul dosing or mixing equipment, or to stick together in an all-fiber clump, with few filaments extending between, around or among aggregate particles. Thus, the wetting agent according to an embodiment improves material-handling options and product uniformity.

It is appreciated that aramid fibers are strong, tough and limber, and difficult to cut. The wetting process provides benefits in that respect as well: soaking the fibers in water or a similar liquid stiffens them and makes them easier to chop cleanly into segments of well-controlled length. Thus, dosing systems that cut segments from a bulk length of soaked fiber just before introduction into the mix may also be used in some manufacturing processes.

During mixing, the wetting agent that initially holds the fibers together soaks into the AC mixture at large and evaporates or is degraded into subproducts, some or all of which evaporate, leaving the reinforcing fiber filaments to be distributed throughout the asphalt concrete mixture (160).

Finally, the AC mixture containing bitumen or another binder, aggregate, reinforcing fibers, and possibly other materials, is spread on a surface (170) and compacted (180). Other surface- or bulk-treatment techniques may also be applied during construction (190). Or, for example, the AC mixture may be spread on a prepared geogrid or geotextile surface, which may provide other favorable characteristics to the finished pavement.

### Reinforcing Fiber Selection

A variety of thin, monofilament or branched fibers are acceptable for use in an embodiment of the invention. For example, one may use polyethylene, polypropylene or nylon, provided that their temperature characteristics are compatible with the temperatures and conditions in the mixing environment. However, in view of the conditions under which embodiments are often used, aromatic polyamide fibers (“aramids”) are preferred. Aramid fibers have good strength and excellent heat-resistance characteristics.

Plain aramid fibers are acceptable, but one may also use fibers that have been treated to alter their surface structure or chemical activity, or coated with a material in a process generally referred to as “sizing.” Fiber treatments and coatings may alter the fibers' physical shape (e.g., making straight filaments curly or kinky), or may create sites at which certain chemical bonds are easier to form. Treatments that affect individual filaments should not be confused with the wetting agent applied to bundles of filaments (i.e., yarns) to create wetted bulk reinforcing fiber.

In some embodiments, mixtures of fibers may be used. For example, a yarn comprising both aramid fibers and glass fibers may be treated as described, or separate aramid and nylon fiber yarns may be treated independently, then combined into a multi-fiber rope before segmentation and mixing.

### Wetting Agent Selection

The main function of a wetting agent in an embodiment of the invention is to hold a bundle of reinforcing fibers together tightly enough to prevent the individual filaments from escaping from the asphalt concrete mixture into the air (or elsewhere that they are not wanted), but not so tightly that the filaments remain clumped together in the finished AC. A suitable wetting agent is one that impedes friation of the reinforcing fibers in a severed segment until the segment is introduced into an AC mixture, and that thereafter sheds filaments from the bundle under the agitation or churning conditions of a mixing plant so that most or all of the filaments in the segment separate and are distributed between and among aggregate particles within the amount of time the mixture is being worked. Note that this time may be significantly shorter than the five to twenty minute mixing time of cement concrete: an asphalt plant making tons of product per hour may only mix ingredients for five to twenty seconds.

Water is often suitable for use as a wetting agent: it is inexpensive, readily available, does not harm most AC mixtures, and evaporates cleanly under most environmental conditions. Water may also be treated with a surfactant (e.g., soap) to improve penetration into the reinforcing fiber yarn. Treatment with an acid or base to adjust the pH may improve adhesion among filaments, asphalt binder and aggregate particles, or may prevent mold and mildew from forming on wet fiber segments in storage. For extremely low temperature use, a wetting agent with a lower freezing point, such as an alcohol, may be used. A colorant or odorant may be added to the wetting agent to help identify the product or its intended application. For example, a blue color may be added to product wetted with a low-temperature wetting agent (i.e., a wetting agent that evaporates at lower temperatures), while a red color may be added to a wetting agent that performs better at higher temperatures. In some embodiments, the wetting agent may oxidize or degrade when exposed to air, to light, or to other ingredients in the AC mixture, and some or all of the subcomponents of such degradation may evaporate or depart from the finished AC.

A basic asphalt process mixes ingredients between about 130° C. and 165° C., but warm-mix and cold-mix asphalt cement may be worked and installed at much lower temperatures, such as 0° C., 25° C. or 50° C. Wetting agents that are liquid at those temperatures, and that evaporate or disappear from the mix (leaving the reinforcing filaments behind) are preferred.

### Alternate Process

Although the preferred process is to treat a linear bundle of reinforcing fibers (e.g., a spool of yarn) with a wetting agent and then to sever the treated bundle into segments of a suitable length, it is also possible to soak pre-cut fibers of uniform or random lengths in the wetting agent. This produces a damp or wet amorphous gloppy mass from which clumps can be added to asphalt concrete during mixing. The fibers in clumps of this material are oriented more-or-less randomly, unlike the mostly-parallel fibers in treated, severed yarns. Like the soaked yarn segments, these clumps shed reinforcing fibers into the asphalt during mixing, but not as evenly, and it may be more difficult to meter this material.

### Reinforcing Fiber Ratio Considerations

As discussed previously, embodiments of the invention produce significant asphalt performance increases with fairly small quantities (by weight or percentage) of reinforcing fibers. For example, adding one kilo of aramid fibers per metric ton of asphalt mix is an 0.1% ratio. (Note that the wetting agent may double or triple the weight of the bare fibers, so an actual mixture may introduce 2-3 kg of the inventive soaked reinforcing fiber per ton of asphalt.)

Introducing significantly larger quantities of treated reinforcing fiber may be economically infeasible (the aramid fiber is much more expensive than aggregate and bitumen), and the numerous, fine filaments provide a large total surface area onto which the bitumen can become coated. In effect, excessive fiber may soak up bitumen and interfere with satisfactory coating and adhesion among the aggregate particles. Therefore, it is important not to assume that “some fibers are good, so more must be better.” Adding more fibers may provide an additional beneficial reinforcing effect, but it may also require adjustment of other ingredient ratios to maintain the expected performance and characteristics of the resulting asphalt concrete. Such a mixture adjustment may increase the cost out of proportion with the improved performance realized.

The materials and processes of the present invention have been described largely by reference to specific examples and in terms of particular fibers and wetting agents. However, those of skill in the art will recognize that reinforcing fibers can be introduced into and distributed throughout an asphalt cement mixture by coating or soaking the fibers with a variety of different liquids, and cutting or dividing them in a variety of ways, without departing from the principles of the invention. Such variations and alternate methods are understood to be captured according to the following claims.

1-14. (canceled)

15. A ready-to-use additive for improving characteristics of asphalt cement concrete, comprising:
a plurality of aramid fiber yarn segments soaked with a wetting agent, each segment comprising a plurality of aramid filaments of similar length bound loosely together by surface tension of the wetting agent; and
an airtight container to prevent the wetting agent from evaporating, wherein
the plurality of soaked aramid fiber yarn segments are stored in the airtight container so that the wetting agent does not evaporate prior to addition of the aramid fiber yarn segments to an asphalt cement concrete mixture.

16. The ready-to-use additive of claim 15 wherein the wetting agent is substantially composed of water.

17. The ready-to-use additive of claim 16 wherein the wetting agent comprises a surfactant.

18. The ready-to-use additive of claim 16 wherein the wetting agent comprises a pH modifier.

19. The ready-to-use additive of claim 16 wherein the wetting agent comprises a colorant.

20. The ready-to-use additive of claim 16 wherein the wetting agent comprises an odorant.

21. A ready-to-use additive for improving characteristics of cold-mix asphalt cement concrete, consisting essentially of:
a plurality of aramid fiber segments, each segment having a length between about 8 mm and about 100 mm;
a wetting agent that exists as a liquid at a temperature between about 0° C. and about 50° C., the plurality of aramid fiber segments soaked with the wetting agent; and
an airtight container to prevent the wetting agent from evaporating from the soaked aramid fiber segments until the soaked aramid fiber segments are metered into an asphalt cement concrete mixture, wherein
the soaked aramid fiber segments are sealed inside the airtight container.
